(19) United States
(12) Patent Application Publication
(10) Pub. No.: US 2017/0032561 A1
(43) Pub. Date: Feb. 2, 2017

(54) METHOD OF GENERATING BITMAP OF THREE-DIMENSIONAL MODEL, DEVICE AND SYSTEM FOR PERFORMING THE SAME

(71) Applicant: SAMSUNG SDS CO., LTD., Seoul (KR)

(72) Inventors: Kwang-Min CHOI, Seoul (KR); Sung-Ho JANG, Seoul (KR); Sang-Hoon HAN, Seoul (KR); Jae-Young PARK, Seoul (KR)

(73) Assignee: SAMSUNG SDS CO., LTD., Seoul (KR)

(21) Appl. No.: 15/009,393

(22) Filed: Jan. 28, 2016

(30) Foreign Application Priority Data
Jul. 30, 2015 (KR) 10-2015-0108282

(51) Int. Cl. G06T 15/00; G06K 15/02; G06T 17/10

(52) U.S. Cl. CPC G06T 15/00; G06T 17/10; G06K 15/02; G06K 15/1836

(57) ABSTRACT

A method of generating bitmaps of a three-dimensional model, and a device and a system for performing the method are disclosed. The bitmap generator includes a model divider configured to divide the three-dimensional model into a plurality of sub models, wherein the three-dimensional model is divided in a direction parallel with an output direction of a three-dimensional printer, a plurality of sub bitmap generators each configured to generate a sub bitmap for a plane perpendicular to the output direction for the plurality of sub models, an operation distributer configured to transfer and distribute the plurality of sub models to the plurality of sub bitmap generators so that an operation of generating the sub bitmaps are processed in parallel, and a bitmap adder configured to merge the sub bitmaps whose coordinates of the output direction are the same among the generated plurality of sub bitmaps.

### CROSS-REFERENCE TO RELATED APPLICATION

This application claims priority to and the benefit of Korean Patent Application No. 10-2015-0108282, filed on Jul. 30, 2015, the disclosure of which is incorporated herein by reference in its entirety.

### BACKGROUND

1. Field

Embodiments of the present disclosure relate to a three-dimensional printing technology.

2. Discussion of Related Art

Early three-dimensional printers were mainly used in producing prototypes, but as printers capable of outputting various colors and materials come out, the application area widens. Particularly, a multi jet modeling (MJM) method capable of outputting with high precision, multiple colors and multiple materials has come into the spotlight.

However, in order to output an object including multiple colors and multiple materials with high precision, a very complicated process of preprocessing (i.e., slicing) is required. For example, assuming that a resolution of the printer is 600 dots per inch (DPI), about one hundred million three-dimensional unit pixels (i.e., voxels) per cubic meter exist. Therefore, a slicing process which includes converting an input model into voxel units, assigning attributes such as color and material to each voxel, and generating bitmaps of two-dimensional stacked planes needs a lot of operation time due to a large amount of calculation.

Here, a parallelization process of the slicing process is required to reduce an operation time, but there is a problem in which parallelization of the slicing process is difficult when a support material region is included in a bitmap of a stacked plane, as in the MJM method. That is, to obtain the support material region in a particular stacked plane, information on all the stacked planes over the corresponding stacked plane should be known. Therefore, it is hard to independently perform a process of obtaining the support material region of each stacked plane, and therefore it is hard to parallelize the slicing process.

### SUMMARY

Exemplary embodiments of the present disclosure are directed to a method of generating bitmaps of a three-dimensional model capable of reducing time required for a slicing operation, and a device and a system for performing the method.

According to an aspect of the present disclosure, a bitmap generator of a three-dimensional model includes a model divider configured to divide the three-dimensional model into a plurality of sub models, wherein the three-dimensional model is divided in a direction parallel with an output direction of a three-dimensional printer, a plurality of sub bitmap generators each configured to generate a sub bitmap for a plane perpendicular to the output direction for the plurality of sub models, an operation distributer configured to transfer and distribute the plurality of sub models to the plurality of sub bitmap generators so that operations of generating the sub bitmaps are processed in parallel, and a bitmap adder configured to merge the sub bitmaps whose coordinates of the output direction are the same among the generated plurality of sub bitmaps.

The model divider may divide the three-dimensional model so that the number of space elements included in each of the plurality of sub models is constant.

The model divider may divide the three-dimensional model so that widths of the plurality of sub models are equal.

Each of the plurality of sub bitmap generators may rasterize each of the plurality of sub models in a direction perpendicular to the output direction, and may determine a type of each pixel generated by the rasterization based on a location relationship with an outline of each of the plurality of sub models.

Each of the plurality of sub bitmap generators may determine a pixel existing on the outline or inside the outline as a pixel corresponding to a part material region.

Each of the plurality of sub bitmap generators may determine a pixel existing outside the outline based on the output direction as a pixel corresponding to a support material region.

The bitmap generator may further include an operation adjuster configured to redistribute operations of generating the sub bitmaps based on a processing degree of the operation of generating the sub bitmaps of the plurality of sub bitmap generators.

The operation adjuster may monitor a remaining degree of operation of the plurality of sub bitmap generators, and may reassign a part of an amount of operation of a sub bitmap generator in which the operation of generating the sub bitmaps is not completed to a sub bitmap generator in which the operation of generating the sub bitmaps is completed.

When a sub bitmap generator in which the operation of generating the sub bitmaps is completed exists, the operation adjuster may check whether a sub bitmap generator in which an amount of a remaining operation is equal to or more than a predetermined critical value exists among sub bitmap generators in which the operation of generating the sub bitmaps is not completed, and may reassign a part of an amount of operation of a sub bitmap generator in which the amount of the remaining operation is equal to or more than the predetermined critical value to the sub bitmap generator in which the operation of generating the sub bitmaps is completed.

According to another aspect of the present disclosure, a method of generating bitmaps of a three-dimensional model includes dividing, in a bitmap generator, the three-dimensional model into a plurality of sub models in a direction parallel with an output direction of a three-dimensional printer, distributing, in the bitmap generator, operations of generating sub bitmaps so that the operations of generating the sub bitmaps for the plurality of sub models are processed in parallel, generating, in the bitmap generator, a sub bitmap for a plane perpendicular to the output direction for each of the plurality of sub models, and merging, in the bitmap generator, the sub bitmaps whose coordinates of the output direction are the same among the generated plurality of sub bitmaps.

The dividing of the three-dimensional model may include dividing, in the bitmap generator, the three-dimensional model so that the number of space elements included in each of the plurality of sub models is constant.

The dividing of the three-dimensional model may include dividing, in the bitmap generator, the three-dimensional model so that widths of the plurality of sub models are equal.

The generating of the sub bitmaps may include rasterizing, in the bitmap generator, each of the plurality of sub models in a direction perpendicular to the output direction, and determining, in the bitmap generator, a type of each pixel generated by the rasterization based on a location relationship with an outline of each of the plurality of sub models.

The determining of the type of each pixel may include determining, in the bitmap generator, a pixel existing on the outline or inside the outline as a pixel corresponding to a part material region.

The determining the type of each pixel may include determining, in the bitmap generator, a pixel existing outside the outline based on the output direction as a pixel corresponding to a support material region.

The method of generating the bitmap may further include redistributing, in the bitmap generator, operations of generating the sub bitmaps based on a processing degree of the operation of generating the sub bitmaps.

The redistributing of the operations of generating the sub bitmaps may include checking, in the bitmap generator, whether a process in which the operation of generating the sub bitmaps is completed exists, and reassigning, in the bitmap generator, a part of an amount of operation of a process in which the operation of generating the sub bitmaps is not completed to a process in which the operation of generating the sub bitmaps is completed.

The redistributing of the operations of generating the sub bitmaps may include checking, in the bitmap generator, whether a process in which the operation of generating the sub bitmaps is completed exists, when a process in which the operation of generating the sub bitmaps is completed exists, checking, in the bitmap generator, whether a sub bitmap generator in which an amount of a remaining operation is equal to or more than a predetermined critical value exists among sub bitmap generators in which the operation of generating the sub bitmaps is not completed, and when a process in which the operation of generating the sub bitmaps is completed exists, reassigning, in the bitmap generator, a part of an amount of operation of a process in which the amount of the remaining operation is equal to or more than the predetermined critical value to the process in which the operation of the sub bitmaps is completed.

According to still another aspect of the present disclosure, a device includes at least one processor, a memory, and at least one program. The at least one program is stored in the memory and executed by the at least one processor. The at least one program may include commands for executing operations which include dividing the three-dimensional model into a plurality of sub models in a direction parallel with an output direction of a three-dimensional printer, distributing operations of generating sub bitmaps so that the operations of generating the sub bitmaps for the plurality of sub models are processed in parallel, generating sub bitmaps for a plane perpendicular to the output direction for each of the plurality of sub models, and merging the sub bitmaps whose coordinates of the output direction are the same among the generated plurality of sub bitmaps.

According to yet another aspect of the present disclosure, a system for providing a printing service includes a bitmap generator. The bitmap generator may perform operations which includes receiving a three-dimensional model, dividing the three-dimensional model into a plurality of sub models in a direction parallel with an output direction of a three-dimensional printer, distributing operations of generating sub bitmaps so that the operations of generating the sub bitmaps for the plurality of sub models are processed in parallel, generating sub bitmaps for a plane perpendicular to the output direction for each of the plurality of sub models, and merging the sub bitmaps whose coordinates of the output direction are the same among the generated plurality of sub bitmaps.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a block diagram illustrating a bitmap generator of a three-dimensional model according to an exemplary embodiment of the present disclosure;

FIG. 2 is a diagram schematically illustrating a process of generating bitmaps of a three-dimensional model using a bitmap generator according to an exemplary embodiment of the present disclosure;

FIG. 3 is a diagram illustrating examples of a pixel column and a vertical cross-section which form a sub model according to an exemplary embodiment of the present disclosure;

FIG. 4 is a diagram illustrating a method of dividing a three-dimensional model by a model divider according to an exemplary embodiment of the present disclosure;

FIG. 5 is a block diagram illustrating a bitmap generator of a three-dimensional model according to another exemplary embodiment of the present disclosure;

FIG. 6 is a diagram illustrating a process of redistributing operations of generating the sub bitmaps by an operation adjuster according to an exemplary embodiment of the present disclosure;

FIG. 7 is a flowchart illustrating a method of generating bitmaps of a three-dimensional model according to an exemplary embodiment of the present disclosure;

FIG. 8 is a block diagram illustrating a printing service system using a bitmap generator of a three-dimensional model according to an exemplary embodiment of the present disclosure; and

FIG. 9 is a diagram illustrating a computing environment including an exemplary computing device suitable for using in the exemplary embodiments of the present disclosure.

### DETAILED DESCRIPTION OF EXEMPLARY EMBODIMENTS

Hereinafter, specific exemplary embodiments of the present disclosure will be described with reference to the drawings. The following detailed description is provided to assist in comprehensive understanding of methods, apparatuses, and/or systems described herein. However, this is merely an example, and the present disclosure is not limited thereto.

When detailed description of known art related to the present disclosure is determined to unnecessarily obscure the subject matter of the present disclosure in describing exemplary embodiments of the present disclosure, the detailed description will be omitted. The terms to be described below are terms defined in consideration of functions in the present disclosure and may be changed according to an intention of a user or an operator or practice. Therefore, definitions thereof will be determined based on content of the entire specification. The terms used in the detailed description are merely intended to describe the exemplary embodiments of the present disclosure and should not be limited in any way. The singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, operations, operations, elements, and/or components, but do not preclude the presence or addition of one or more other features, integers, operations, operations, elements, components, and/or groups thereof.

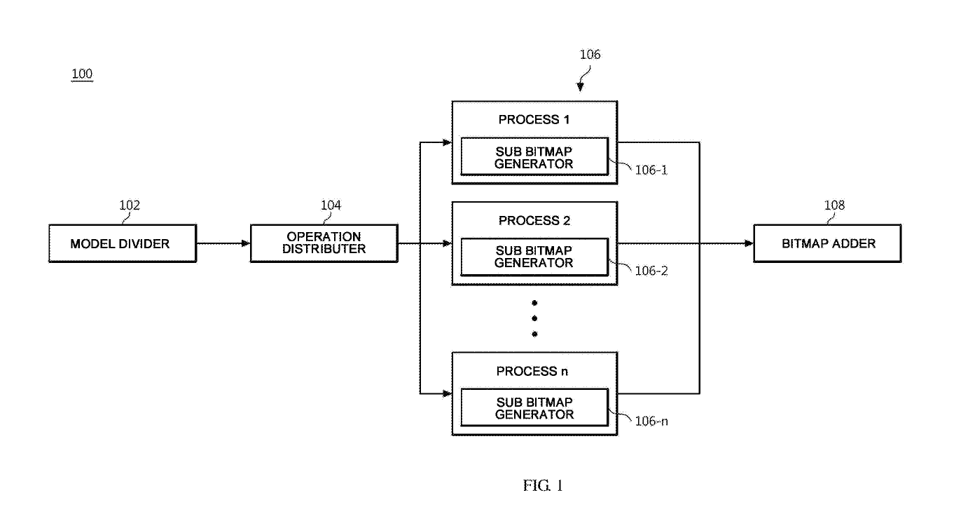

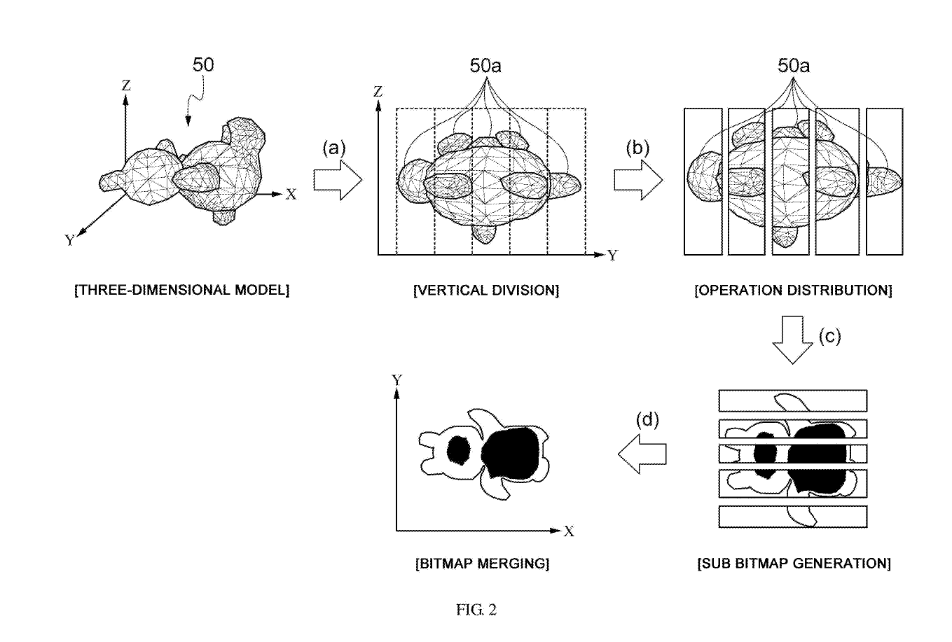

FIG. 1 is a block diagram illustrating a bitmap generator of a three-dimensional model according to an exemplary embodiment of the present disclosure, and FIG. 2 is a diagram schematically illustrating a process of generating bitmaps of a three-dimensional model using a bitmap generator according to an exemplary embodiment of the present disclosure.

Referring to FIGS. 1 and 2, a bitmap generator 100 of a three-dimensional model may include a model divider 102, an operation distributer 104, a plurality of sub bitmap generators 106, and a bitmap adder 108.

The bitmap generator 100 receives a three-dimensional model and generates bitmaps for an output of a three-dimensional printer. Here, the three-dimensional model, for example, may refer to a file of an STL format. The bitmap generator 100 of a three-dimensional model, for example, may be included in a configuration of a device capable of data storage and operation, such as a server connected to the three-dimensional printer through a network, or a personal computer. However, the bitmap generator 100 of a three-dimensional model may not be restricted by the above, but may be included in a configuration of the three-dimensional printer.

The model divider 102 divides a received three-dimensional model into a plurality of sub models. The model divider 102 divides the three-dimensional model in a direction parallel with an output direction of a three-dimensional printer (hereinafter, referred to as an output direction), i.e., in a direction parallel with a direction of gravity.

As a specific example, referring to part (a) of FIG. 2, assuming that the output direction of the three-dimensional printer is a direction of a Z-axis in FIG. 2, the model divider 102 may divide a three-dimensional model 50 parallel with the direction of the Z-axis in a three-dimensional space in which the three-dimensional model 50 is included, and classify the three-dimensional model 50 into a plurality of sub models 50a. In FIG. 2, it is illustrated that the model divider 102 divides the three-dimensional model 50 so that a cross-section of the plurality of sub models 50a is parallel with a Z-X plane, however, the present disclosure is not limited by the above, but the cross-section of the plurality of sub models 50a may be parallel with a Z-Y plane.

Here, widths of the plurality of divided sub models 50a may be the same or not the same. When the cross-section of each sub model 50a is divided parallel with the Z-X plane, the width of each sub model 50a may refer to a width in a Y-axis direction of a corresponding sub model 50a. When the cross-section of each sub model 50a is divided parallel with the Z-Y plane, the width of each sub model 50a may refer to a width in an X-axis direction of a corresponding sub model 50a.

Here, the sub models 50a may be a group of pixel columns or a group of vertical cross-sections. Here, the pixel column may refer to a rectangular parallelepiped in which pixels of bitmaps are stacked in an output direction. The vertical cross-section may refer to a plane (i.e., the Z-X plane or the Z-Y plane) which is parallel with a Z-axis in a three-dimensional space in which the three-dimensional model 50 is included.

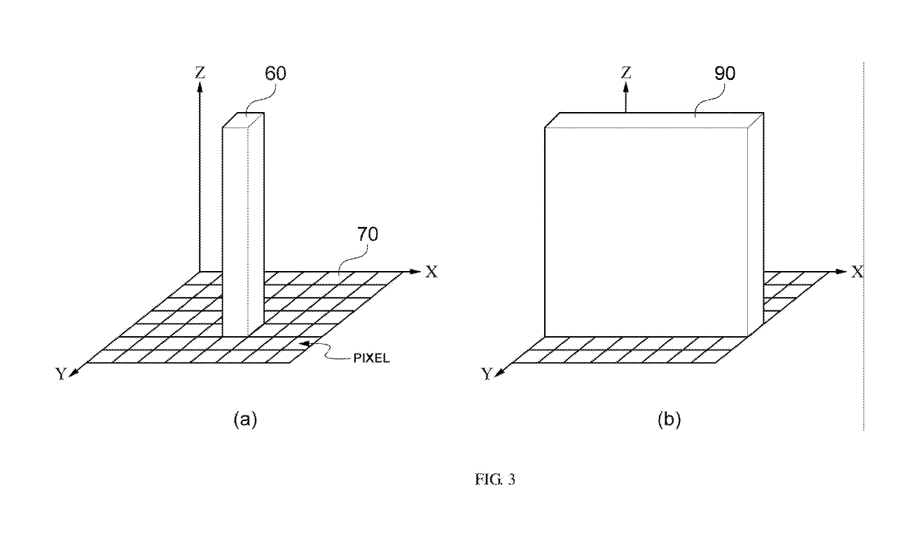

As a specific example, referring to part (a) of FIG. 3, assuming that the output direction of the three-dimensional printer is a direction of the Z-axis in the illustrated embodiment, a pixel column 60 may refer to pixels stacked in a Z direction. Further, in the illustrated embodiment, a portion 70 represented with a lattice pattern on an X-Y plane refers to a group of pixels included in a plane perpendicular to the output direction of the three-dimensional printer. Further, referring to part (b) of FIG. 3, assuming that the output direction of the three-dimensional printer is a direction of the Z-axis in the illustrated embodiment, a vertical cross-section 90 may be a Z-X plane having a width of one pixel.

As described above, since the three-dimensional model 50 is divided in a direction parallel with an output direction, i.e., a direction of gravity, (hereinafter, it may be referred to as a vertical direction), the divided sub models 50a may include information on horizontal stacked planes (i.e., a stacked plane perpendicular to the output direction (hereinafter, it may be referred to as a horizontal direction)), thereby obtaining information required to generate a support material region. The support material region refers to a region in which a support material is filled, and the support material forms a support fixture for supporting a portion floating in the air when the three-dimensional model 50 is output. Here, each of the divided sub models 50a itself may include information required to generate a support material region so that a slicing operation of one sub model may be performed independently of the other sub models, and therefore parallelization of the slicing process may be possible.

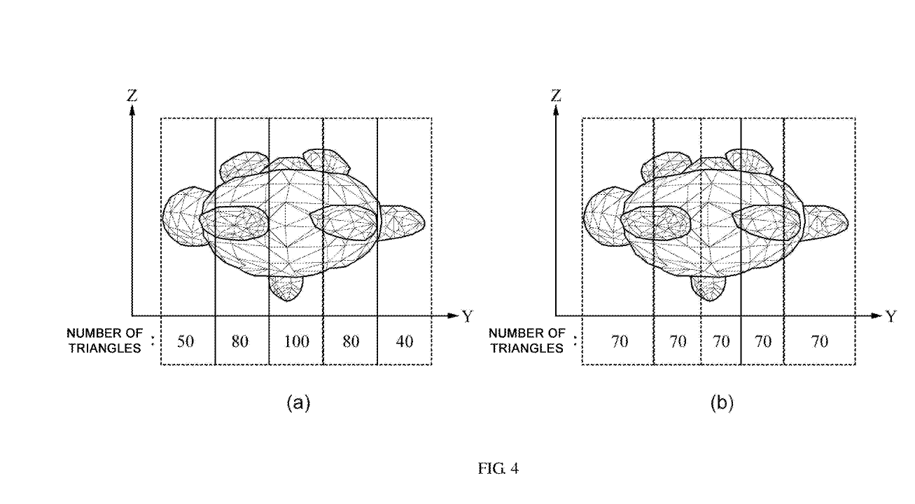

Further, the model divider 102 may divide the three-dimensional model 50 so that the number of space elements (for example, a triangle, an apex, a line segment, etc.) included in each of the plurality of sub models 50a is constant. Here, a width of each of the plurality of sub models 50a may vary according to a distribution of the space elements in the three-dimensional model 50. Further, the model divider 102 may divide the three-dimensional model 50 so that the widths of the plurality of sub models 50a are equal. Here, the number of space elements included in each of the plurality of sub models 50a may vary according to the distribution of the space elements in the three-dimensional model 50. This will be described with reference to FIG. 4. In FIG. 4, for convenience of description, the case in which space elements forming the three-dimensional model 50 are triangular meshes is shown.

Referring to FIG. 4A, the three-dimensional model 50 is divided so that the widths of the plurality of sub models 50a are equal. Here, the number of space elements (i.e., the number of triangles) included in each of the plurality of sub models 50a may be 50, 80, 100, 80, and 40.

Referring to FIG. 4B, the three-dimensional model 50 is divided that the number of space elements (i.e., triangles) included in each of the plurality of sub models 50a is constant. That is, the three-dimensional model 50 is divided so that the number of triangles included in each of the plurality of sub models 50a is 70. As described above, when the three-dimensional model 50 is divided so that the number of space elements included in each of the plurality of sub models 50a is constant, efficiency of parallelized processing by a sub bitmap generator 106 described below may be increased.

The operation distributer 104 assigns the plurality of sub models 50a to a plurality of sub bitmap generators 106-1 to 106-n, respectively. That is, the operation distributer 104 transfers and distributes the plurality of sub models 50a to the plurality of sub bitmap generators 106-1 to 106-n, respectively. In FIG. 2B, a distributed state of each of the plurality of sub models 50a is schematically shown.

When the model divider 102 divides the three-dimensional model 50 into n sub models 50a, the operation distributer 104 may transfer and distribute the n sub models 50a to n sub bitmap generators 106-1 to 106-n, respectively. Here, the process of operation distribution may include a process of copying and shifting a corresponding sub model 50a to an operation space (for example, a memory, a disk, etc.) of each of the sub bitmap generators 106-1 to 106-n.

Each of the sub bitmap generators 106-1 to 106-n generates a bitmap for an assigned sub model 50a. Hereinafter, a bitmap for the sub model 50a may be referred to as “sub bitmap”. Here, each of the sub bitmap generators 106-1 to 106-n processes each sub model 50a by an independent process (i.e., a parallel processing), and therefore an operation time may be reduced. Process 1 to process n shown in FIG. 1 may denote a logical and/or physical execution flow which is simultaneously executable. Process 1 to process n may be performed by separate processors. However, this disclosure is not limited by the above, but process 1 to process n may be performed by at least one processor on a per-thread basis.

Specifically, each of the sub bitmap generators 106-1 to 106-n may rasterize a corresponding sub model 50a in a direction perpendicular to the output direction (i.e., a horizontal direction). Each of the sub bitmap generators 106-1 to 106-n may rasterize a corresponding sub model 50a using a rasterization technology such as a scan-line conversion, etc. Each of the sub bitmap generators 106-1 to 106-n may merge pixels generated by the rasterization to generate a sub bitmap for a part of planes perpendicular to the output direction. Each of the sub bitmap generators 106-1 to 106-n may merge the pixels whose coordinates on the Z-axis are the same among the generated plurality of pixels generated by the rasterization to generate the sub bitmap for a plane perpendicular to the output direction. Here, each of the sub bitmap generators 106-1 to 106-n may sequentially generate a sub bitmap for a part of the planes perpendicular to the output direction based on a coordinate value of each output direction, while sequentially increasing a coordinate value on the Z-axis from the lowest end. In FIG. 2C, a sub bitmap generated for each of the plurality of sub models 50a is schematically shown. Here, for convenience of description, a sub bitmap for each plane perpendicular to the output direction based on a predetermined coordinate value of the Z-axis is shown.

For example, the sub bitmap generator 106-1 may merge pixels of which a coordinate on the Z-axis is c (a coordinate value at a lowest end on Z-axis of a corresponding sub model) to generate a sub bitmap for a part of the planes perpendicular to the output direction. This corresponds to a sub bitmap for a layer which is output in a c^{th} order in the output of the three-dimensional printer. Then, the sub bitmap generator 106-1 may merge pixels of which a coordinate on the Z-axis is c+1 to generate a sub bitmap for a part of the planes perpendicular to the output direction. This corresponds to a sub bitmap for a layer which is output in a (c+1)^{th} order in the output of the three-dimensional printer. As described above, the sub bitmap generator 106-1 may sequentially generate a sub bitmap, while sequentially increasing a coordinate value on the Z-axis from the lowest end.

Each of the sub bitmap generators 106-1 to 106-n may determine types of pixels generated by rasterization. Here, the types of pixels may include pixels corresponding to a part material region, pixels corresponding to a support material region, and pixels corresponding to an empty space. Specifically, the part material region refers to a region corresponding to the three-dimensional model output from the three-dimensional printer. Further, the support material region refers to a region in which a support material is filled, and the support material forms a support fixture for supporting a portion floating in the air when the three-dimensional model is output. Further, the empty space refers to a region not corresponding to the part material region and the support material region. Pixels corresponding to the part material region have pixel values in the process of rasterization, and pixels corresponding to the support material region and the empty space do not have pixel values in the process of rasterization.

In an exemplary embodiment, each of the sub bitmap generators 106-1 to 106-n may obtain an outline of a corresponding sub model 50a, and then may determine a type of each pixel based on a location relationship with an outline of each of the plurality of sub models 50a. Specifically, each of the sub bitmap generators 106-1 to 106-n may determine a pixel existing on the outline or inside the outline as a pixel corresponding to the part material region, and may determine a pixel existing outside of the outline as a pixel corresponding to the support material region or the empty space. Here, when the outline of a corresponding sub model 50a exists above a pixel in a direction of the Z-axis, the corresponding pixel may be determined as pixels corresponding to the support material region. On the contrary, when the outline of a corresponding sub model 50a does not exist above a pixel in the direction of the Z-axis, the corresponding pixel may be determined as pixels corresponding to the empty space.

Here, a process of obtaining the outline of the sub model 50a will be described below. Assuming that the output direction is a direction of the Z-axis, a plurality of planes parallel with the output direction are generated, while changing coordinate values of the X-axis or the Y-axis in an arbitrary plane equation. Here, a distance between planes may be determined by the resolution of the three-dimensional printer. However, this disclosure is not limited by the above, but the distance between planes may be determined by various rules in addition to the resolution. Then, a crossing point of each generated plane and the sub model 50a is calculated to obtain a cross-section outline of the sub model 50a on each plane. The bitmap adder 108 merges a plurality of sub bitmaps generated by the sub bitmap generators 106-1 to 106-n, and generates bitmaps for all of the planes perpendicular to the output direction. Specifically, the bitmap adder 108 merges the sub bitmaps whose coordinates of the output direction (i.e., the Z-axis) are the same among the generated plurality of sub bitmaps. That is, the sub bitmaps are sub bitmaps for a part of the planes perpendicular to the output direction at the same value of the Z-axis, and therefore the bitmap adder 108 merges these sub bitmaps and generates sub bitmaps for all of the planes perpendicular to the output direction at a corresponding coordinate value of the Z-axis. The bitmap adder 108, when merging sub bitmaps which have the same coordinate of the Z-axis, may arrange sub bitmaps and then merge the sub bitmaps considering the X-axis and the Y-axis of a sub bitmap. In FIG. 2D, a merged state of sub bitmaps having the same coordinate value of the Z-axis is schematically shown. The bitmap adder 108 may merge sub bitmaps having the same coordinate value of the Z-axis, and sequentially generate bitmaps for all of the planes perpendicular to the output direction at a corresponding coordinate value of the Z-axis, while increasing a coordinate value of the Z-axis from the lowest end.

According to an exemplary embodiment, the three-dimensional model 50 may be divided in a direction parallel with the output direction and the sub model 50a may include information on horizontal stacked planes, so that a slicing operation may be performed through parallel processing with respect to a plurality of sub models, and therefore time consumed in the slicing operation may be reduced, and the support material region may also be easily obtained.

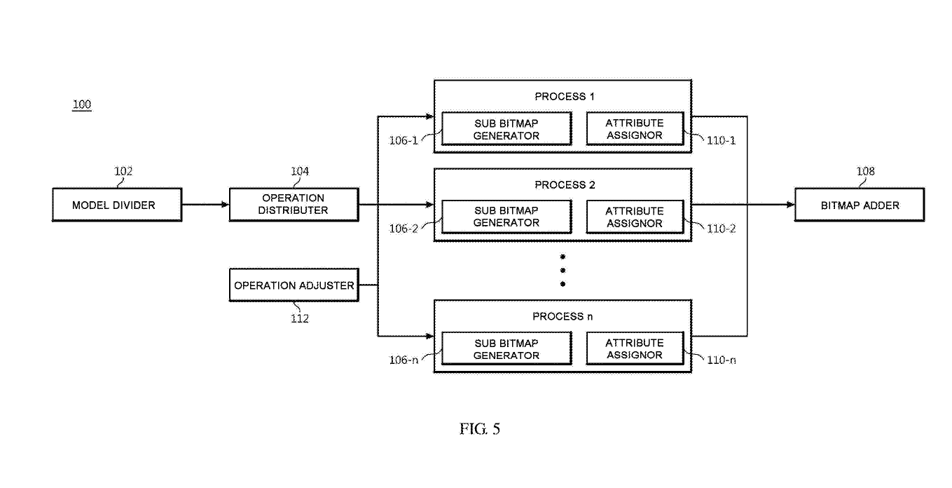

FIG. 5 is a block diagram illustrating a bitmap generator of a three-dimensional model according to another exemplary embodiment of the present disclosure. Hereinafter, portions different from the embodiment shown in FIG. 1 will be described in detail.

Referring to FIG. 5, a bitmap generator 100 of a three-dimensional model may include a model divider 102, an operation distributer 104, a plurality of sub bitmap generators 106, a bitmap adder 108, a plurality of attribute assignors 110, and an operation adjuster 112. Here, the model divider 102, the operation distributer 104, the plurality of sub bitmap generators 106, and the bitmap adder 108 are the same or similar to those shown in FIG. 1, and therefore detailed descriptions of them will be omitted.

Each of the attribute assignors 110-1 to 110-n may perform a predetermined operation in association with each of the sub bitmap generators 106-1 to 106-n. Specifically, each of the attribute assignors 110-1 to 110-n may perform an operation of assigning at least one attribute to a pixel corresponding to a part material region of each sub bitmap generated by each of the sub bitmap generators 106-1 to 106-n. Here, the attribute may include a color, the quality of a material, etc. However, the attribute is not limited by the above, but may include various items capable of changing an output object output from the three-dimensional printer in addition to the color and the quality of the material. Here, each of the sub bitmap generators 106-1 to 106-n and each of the corresponding attribute assignors 110-1 to 110-n may operate by an independent process. That is, in FIG. 5, a process 1 may perform operations of generating sub bitmaps and attribute assignment for a first sub model, a process 2 may perform operations of generating sub bitmaps and attribute assignment for a second sub model, and a process n may perform operations of generating sub bitmaps and attribute assignment for an n^{th} sub model. Processes 1 to n may be performed in parallel in the bitmap generator 100.

Specifically, each of the attribute assignors 110-1 to 110-n may extract internal coordinates located within a predetermined offset distance from an outer surface of a corresponding sub model 50a, and may assign information on the color to pixels corresponding to the extracted internal coordinates. Here, the internal coordinates denote coordinates to which color information is assigned among coordinates existing inside of the sub model 50a. When color information is assigned to all of the coordinates existing inside of the sub model 50a, an amount of operation due to an assignment of color information may increase. Further, the sub model 50a generally has a predetermined transparency, and therefore a color of a coordinate located at a point distant from an outer surface of the sub model 50a by a certain distance may not affect a color visible from the outside. Therefore, in the embodiment of the present disclosure, color information is assigned to internal coordinates located within a predetermined offset distance from an outer surface of the sub model 50a among coordinates existing inside of the sub model 50a, and therefore the amount of operation due to an assignment of color information may be minimized. Here, the offset distance may vary according to a transparency of the corresponding sub model 50a.

The operation adjuster 112 may redistribute operations of generating the sub bitmaps based on a processing degree of each of the sub bitmap generators 106-1 to 106-n. Specifically, the operation adjuster 112 may monitor a degree of operation of each of the plurality of sub bitmap generators 106-1 to 106-n. That is, each of the sub bitmap generators 106-1 to 106-n may sequentially generate a sub bitmap for a part of planes perpendicular to the output direction based on a coordinate value of each output direction while increasing a coordinate value of the Z-axis from the lowest end, and the operation adjuster 112 may monitor a remaining degree of operation with respect to the plurality of sub bitmap generators 106-1 to 106-n. Here, each of the plurality of sub bitmap generators 106-1 to 106-n may transfer information on the number of remaining horizontal layers to the operation adjuster 112 whenever an operation of generating sub bitmaps for one horizontal layer (i.e., a layer perpendicular to a direction of the Z-axis and having a height of one pixel) is completed. Therefore, the operation adjuster 112 may also check whether the operation of each of the sub bitmap generators 106-1 to 106-n is completed.

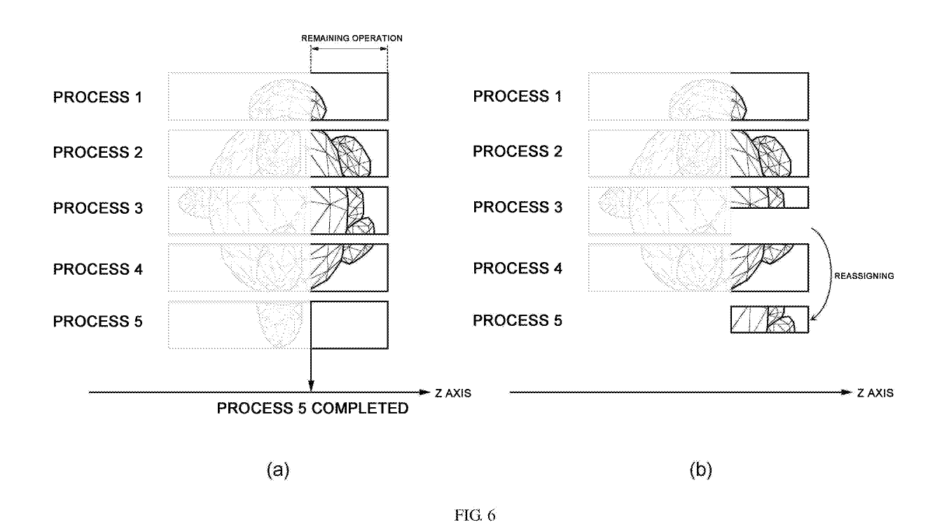

When a sub bitmap generator 106 in which the operation is completed exists, the operation adjuster 112 may reassign a part of the amount of operation of a sub bitmap generator 106 in which the amount of the remaining operation is equal to or more than the predetermined critical value to the sub bitmap generator 106 in which the operation of generating the sub bitmaps is completed. This will be described in detail with reference to FIG. 6.

FIG. 6 is a diagram illustrating a process of redistributing operations of generating the sub bitmaps by an operation adjuster according to an exemplary embodiment of the present disclosure.

Referring to FIG. 6, the operation adjuster 112 monitors a remaining degree of operation with respect to each of the plurality of sub bitmap generators 106-1 to 106-n. That is, the operation adjuster 112 may monitor a processing degree of operation of each of the process 1 to a process 5 with respect to each of the plurality of sub bitmap generators 106-1 to 106-n (see FIG. 6A). Each of the process 1 to the process 5 performs a process of sequentially generating sub bitmaps for a part of the planes perpendicular to the output direction along the Z-axis with respect to a corresponding sub model 50a.

When an operation of the process 5 is completed and it is confirmed that the remaining operation of the process 3 is equal to or more than the predetermined critical value, the operation adjuster 112 may reassign a part of a remaining operation of the process 3 (i.e., a part of a sub model in which an operation of a sub bitmap is not completed) to the process 5 in which a process is completed. Here, the operation adjuster 112 may reassign a half of the remaining operation of the process 3 to the process 5.

As described above, the distribution of operations of generating sub bitmaps is readjusted according to a processing degree of an operation of each of the plurality of sub bitmap generators 106-1 to 106-n, and therefore an operation of slicing may be more efficiently processed, and time consumed in the slicing operation may be reduced.

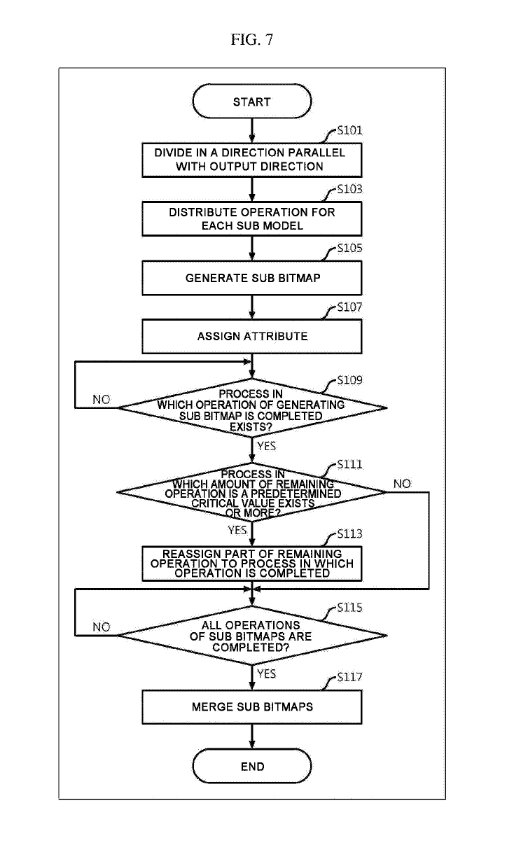

FIG. 7 is a flowchart illustrating a method of generating bitmaps of a three-dimensional model according to an exemplary embodiment of the present disclosure.

The method illustrated in FIG. 7, for example, may be performed by the bitmap generator 100 of a three-dimensional model. In the flowchart, the method is described by a plurality of divided steps, however at least a part of the steps may be performed with a changed order, may be combined with other steps and then performed, may be omitted, may be divided into detailed steps and then performed, or may be performed with at least one added step which is not shown.

Referring to FIG. 7, the model divider 102 divides the three-dimensional model 50 in a direction parallel with an output direction of a three-dimensional printer (S101). That is, the model divider 102 divides the three-dimensional model 50 in a vertical direction and classifies the three-dimensional model 50 into a plurality of sub models 50a. Here, the model divider 102 may divide the three-dimensional model 50 so that the number of space elements (for example, a triangle, an apex, a line segment, etc.) included in each of the plurality of sub models 50a is constant.

Then, the operation distributer 104 assigns the plurality of sub models 50a to the plurality of sub bitmap generators 106-1 to 106-n, respectively (S103).

Then, each of the sub bitmap generators 106-1 to 106-n generates a bitmap for each sub model 50a (S105).

Then, each of the attribute assignors 110-1 to 110-n assigns at least one attribute to a pixel corresponding to a part material region of each sub bitmap (S107). Here, the attribute may include a color, the quality of a material, etc. However, the attribute is not limited by the above, but may include various items capable of changing an output object output from the three-dimensional printer in addition to the color and the quality of the material.

Then, the operation adjuster 112 may check whether a sub bitmap generator 106 in which the operation of generating the sub bitmaps is completed exists (S109). According to the checking result of operation S109, when a sub bitmap generator 106 in which the operation is completed exists, the operation adjuster 112 may check whether a sub bitmap generator in which an amount of a remaining operation is equal to or more than a predetermined critical value exists among sub bitmap generators in which the operation of generating the sub bitmaps is not completed (S111).

According to the checking result of operation S110, when a sub bitmap generator 106 in which an amount of a remaining operation is equal to or more than a predetermined critical value exists, the operation adjuster 112 may reassign a part of an amount of operation of a sub bitmap generator 106 in which the amount of the remaining operation is equal to or more than the predetermined critical value to the sub bitmap generator 106 in which the operation of generating the sub bitmaps is completed (S113).

Then, a bitmap adder 108 merges a plurality of sub bitmaps (S117) when the overall operations of sub bitmaps are completed (S115).

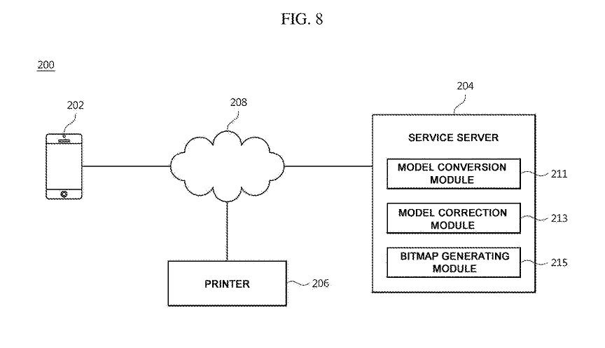

FIG. 8 is a block diagram illustrating a printing service system using a bitmap generator of a three-dimensional model according to an exemplary embodiment of the present disclosure.

Referring to FIG. 8, the printing service system 200 may include a user terminal 202, a service server 204, and a printer 206. The user terminal 202 and the service server 204 may be connected to communicate with each other through a network 208. Further, the service server 204 and the printer 206 may be connected to communicate with each other through the network 208. The network 208, for example, may be a local area network (LAN), a wide area network (WAN), a cellular network or the Internet, however the network 208 is not limited by the above.

The user terminal 202 may include various types of wireless communication devices and wired communication devices, such as a cellular phone, a smart phone, a tablet, a note book, a desk top, etc., which are capable of accessing the service server 204 through the network 208. The user terminal 202 may transmit a three-dimensional model for three-dimensional printing to the service server 204. The three-dimensional model may be data scanned by a three-dimension scanner or drawing data in which a certain object is designed. For example, the three-dimensional model may be formed in a file format such as STL, VRML, PLY, SFX, etc.

The service server 204 may include a model conversion module 211, a model correction module 213, and a bitmap generating module 215. The model conversion module 211 may convert the three-dimensional model received from the user terminal 202 to a file format which can be output by the printer 206. The model correction module 213 may detect errors in the received three-dimensional model, recover the detected errors, and correct the three-dimensional model. The bitmap generating module 215, for example, may be the bitmap generator 100 of a three-dimensional model. The service server 204 may transmit bitmaps generated by the bitmap generating module 215 to the printer 206.

The printer 206 is a three-dimensional printer and may perform an operation of three-dimensional printing according to bitmaps received from the service server 204.

Here, the embodiment in which the bitmap generator 100 is a part of the service server 204 is described, however, the bitmap generator 100 is not limited by the above but may be implemented as a part of the user terminal 202 or a part of the printer 206.

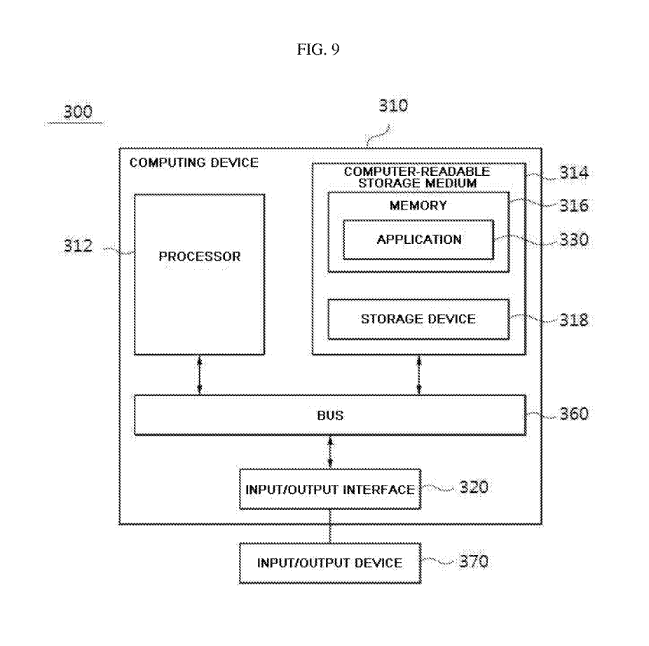

FIG. 9 is a diagram illustrating a computing environment including an exemplary computing device suitable for using in the exemplary embodiments of the present disclosure.

A computing environment 300 may include a computing device 310. Generally, each element may have a different function and ability, and may additionally include components suitable for the elements. The computing device 310 may be a device (for example, the bitmap generator 100 or the service server 204) for generating bitmaps of a three-dimensional model.

The computing device 310 may include at least one processor 312, a computer-readable storage medium 314, and a bus 360. The processor 312 is connected to the bus 360, and the bus 360 connects various other components of the computing device 310, including the computer-readable storage medium 314, to the processor 312.

The processor 312 may enable the computing device 310 to operate according to the embodiment of the present disclosure described above. For example, the processor 312 may execute computer-executable commands stored in the computer-readable storage medium 314, and computer-executable commands stored in the computer-readable storage medium 314, when executed by the processor 312, may enable the computing device 310 to perform operations according to the exemplary embodiment.

The computer-readable storage medium 314 may store computer-executable commands or program codes (for example, commands included in an application 330), program data (for example, data used by the application 330), and/or another suitable type of information. The application 330 stored in the computer-readable storage medium 314 may include a certain group of commands executable by the processor 312.

A memory 316 and a storage device 318 are examples of the computer-readable storage medium 314. In the memory 316, computer-executable commands may be loaded. Further, program data may be stored in the memory 316. For example, the memory 316 may include a volatile memory such as a random access memory, a non-volatile memory, or a suitable combination thereof. In another example, the storage device 318 may include at least one detachable or fixed component for storing information. For example, the storage device 318 may include a hard disk, a flash memory, a magnetic disk, an optical disk, other types of media which are accessible by the computing device 310 and in which information may be stored, or a suitable combination thereof.

Further, the computing device 310 may include at least one input/output interface 320 which provides interface for at least one input/output device 370. The input/output interface 320 may be connected to the bus 360. The input/output device 370 may be connected to the computing device 310 (other components of the computing device 310) through the input/output interface 320. The input/output device 370 may include input devices such as a pointing device, a keyboard, a touch input device, a sound input device, a sensor device and/or an imaging device, and/or output devices such as a display device, a printer, a speaker and/or a network card.

Meanwhile, an exemplary embodiment of the present disclosure may include computer-readable storage media including a program for performing a process described in the specification in the computer. The computer-readable storage media may include program commands, a local data file, and a local data structure as a single form or combination thereof. The computer-readable storage media may be particularly designed and constructed for the present disclosure. Examples of the computer-readable storage media may include magnetic media such as a hard disk, a floppy disk and a magnetic tape, optical recoding media such as CD-ROM and DVD, magneto-optical media such as a floptical disk, and a hardware device such as a ROM, RAM and a flash memory, which have special structure to store and execute program commands. Examples of program commands may include not only machine codes made by a compiler but also high level language codes executable by the computer using an interpreter.

According to exemplary embodiments, a three-dimensional model is divided in a direction parallel with an output direction and a sub model includes information on horizontal stacked planes, and therefore a slicing operation may be performed through parallel processing with respect to a plurality of sub models and time consumed in the slicing operation can be reduced, and in addition, a support material region can also be easily obtained. Further, a distribution of a sub bitmap generation operation is readjusted based on a processing degree of the sub bitmap generation operation, and therefore the slicing operation can be processed more efficiently, and time required for the slicing operation can be further reduced.

While the representative exemplary embodiments of the present disclosure have been described in detail, a person skilled in the art to which the present disclosure pertains will understand that several variations can be made to the exemplary embodiments without departing from the scope of the present disclosure. Therefore, the scope of the present disclosure should not be limited to the described exemplary embodiments, and should be determined by the claims to be described below and their equivalents.

What is claimed is:

1. A bitmap generator for generating bitmaps of a three-dimensional model for use by a three-dimensional printer, comprising:
a model divider configured to divide the three-dimensional model into a plurality of sub models, such that an interface between adjacent sub models extends in a direction parallel with an output direction of the three-dimensional printer;
a plurality of sub bitmap generators, each configured to generate a sub bitmap of a plane of a sub model from among the plurality of sub models, wherein the plane is perpendicular to the output direction;
an operation distributer configured to transfer and distribute each of the plurality of sub models to a respective one of the plurality of sub bitmap generators, such that a plurality of sub bitmaps are generated concurrently; and
a bitmap adder configured to merge sub bitmaps from among the plurality of sub bitmaps having a corresponding coordinate in the output direction.

2. The bitmap generator of claim 1, wherein the model divider is further configured to divide the three-dimensional model such that the number of space elements included in each of the plurality of sub models is equal.

3. The bitmap generator of claim 1, wherein the model divider is further configured to divide the three-dimensional model such that widths of each of the plurality of sub models are equal.

4. The bitmap generator of claim 1, wherein each of the plurality of sub bitmap generators is further configured to rasterize the sub model in a direction perpendicular to the output direction, and to determine a type of each pixel generated by the rasterization based on a location relationship with an outline of the sub model.

5. The bitmap generator of claim 4, wherein each of the plurality of sub bitmap generators is further configured to determine that a pixel existing on or inside the outline corresponds to a part material region.

6. The bitmap generator of claim 4, wherein each of the plurality of sub bitmap generators is further configured to determine that a pixel existing outside the outline based on the output direction corresponds to a support material region.

7. The bitmap generator of claim 1, further comprising an operation adjuster configured to redistribute one or more of the plurality of sub models in response to a processing degree of the plurality of sub bitmap generators.

8. The bitmap generator of claim 7, wherein the operation adjuster is further configured to monitor a remaining degree of operation of each of the plurality of sub bitmap generators, and to reassign a portion of an operation of a sub bitmap generator in which an operation of generating sub bitmaps is not completed to a sub bitmap generator in which an operation of generating sub bitmaps is completed.

9. The bitmap generator of claim 8, wherein the operation adjuster is further configured to check, in response to a sub-bitmap generator completing an operation of generating sub-bitmaps, whether a sub bitmap generator in which an amount of a remaining operation is equal to or more than a predetermined value exists from among the plurality of sub bitmap generators, and to reassign a portion of the operation of the sub bitmap generator in which the amount of the remaining operation is equal to or more than the predetermined value to the sub bitmap generator in which the operation of generating sub bitmaps is completed.

10. A method of generating bitmaps of a three-dimensional model for use by a three-dimensional printer, comprising:
dividing the three-dimensional model into a plurality of sub models such that an interface between adjacent sub models extends in a direction parallel with an output direction of the three-dimensional printer;
distributing operations of generating sub bitmaps of the plurality of sub models such that the operations of generating the sub bitmaps of the plurality of sub models are processed concurrently;
generating sub bitmaps of a plane perpendicular to the output direction for each of the plurality of sub models; and
merging sub bitmaps having a corresponding coordinate in the output direction.

11. The method of claim 10, wherein the dividing the three-dimensional model comprises dividing the three-dimensional model such that the number of space elements included in each of the plurality of sub models is equal.

12. The method of claim 10, wherein the dividing of the three-dimensional model comprises dividing the three-dimensional model such that widths of each of the plurality of sub models are equal.

13. The method of claim 10, wherein the generating of the sub bitmaps comprises:
rasterizing each of the plurality of sub models in a direction perpendicular to the output direction; and
determining a type of each pixel generated by the rasterization based on a location relationship with an outline of each of the plurality of sub models.

14. The method of claim 13, wherein the determining the type of each pixel comprises determining that a pixel existing on or inside the outline corresponds to a part material region.

15. The method of claim 13, wherein the determining the type of each pixel comprises determining that a pixel existing outside the outline based on the output direction corresponds to a support material region.

16. The method of claim 10, further comprising redistributing the operations of generating the sub bitmaps based on a processing degree of the operations of generating the sub bitmaps.

17. The method of claim 16, wherein the redistributing the operations of generating the sub bitmaps comprises:
checking whether a process in which an operation of generating sub bitmaps is completed exists; and
reassigning a portion of a process in which an operation of generating sub bitmaps is not completed to the process in which the operation of generating sub bitmaps is completed.

18. The method of claim 16, wherein the redistributing the operations of generating the sub bitmaps comprises:
checking whether a process in which an operation of generating sub bitmaps is completed exists; and
when the process in which the operation of generating sub bitmaps is completed exists:
checking whether a process in which an amount of a remaining operation is equal to or more than a predetermined value exists; and
reassigning a portion of the process in which the amount of the remaining operation is equal to or more than the predetermined critical value to the process in which the operation of generating sub bitmaps is completed.

19. A non-transitory computer readable medium storing a computer program, the computer program causing a computer to perform the operations comprising:
dividing a three-dimensional model into a plurality of sub models such that an interface between adjacent sub-models extends in a direction parallel with an output direction of a three-dimensional printer;
distributing operations of generating sub bitmaps of the plurality of sub models such that the operations of generating the sub bitmaps of the plurality of sub models are processed in concurrently;
generating sub bitmaps of a plane perpendicular to the output direction for each of the plurality of sub models; and
merging sub bitmaps having a corresponding coordinate in the output direction.

20. A device comprising:
at least one processor;
a memory; and
at least one computer program,
wherein the at least one computer program is stored in the memory and executable by the at least one processor, and
wherein the at least one computer program comprises commands for executing operations comprising:
dividing a three-dimensional model into a plurality of sub models such that an interface between adjacent sub models extends in a direction parallel with an output direction of a three-dimensional printer;
distributing operations of generating sub bitmaps of the plurality of sub models such that the operations of generating the sub bitmaps of the plurality of sub models are processed concurrently;
generating sub bitmaps of a plane perpendicular to the output direction for each of the plurality of sub models; and
merging sub bitmaps having a corresponding coordinate in the output direction.

21. A system for providing a printing service, comprising:
a user terminal;
a service center; and
a three-dimensional printer,
wherein the user terminal, the service center, and the three-dimensional printer are connected through a communication network, and
wherein the service center includes a bitmap generator, wherein the bitmap generator is configured to perform operations including:
receiving a three-dimensional model;
dividing the three-dimensional model into a plurality of sub models such that an interface between adjacent sub models extends in a direction parallel with an output direction of the three-dimensional printer;
distributing operations of generating sub bitmaps of the plurality of sub models such that the operations of generating the sub bitmaps of the plurality of sub models are processed concurrently;
generating sub bitmaps of a plane perpendicular to the output direction for each of the plurality of sub models; and
merging sub bitmaps having a corresponding coordinate in the output direction are the same among the generated plurality of sub bitmaps.

22. A method of providing a bitmap of a three-dimensional model to a three-dimensional printer, comprising:
receiving the three-dimensional model;
dividing the three-dimensional model into a plurality of sub-models along a direction orthogonal to an output direction of the three-dimensional printer;
assigning a first sub model from among the plurality of sub models to a first processor, and assigning a second sub model from among the plurality of sub models to a second processor;
simultaneously using the first processor to generate a sub bitmap of a plane of the first sub model and using the second processor to generator a sub bitmap of a plane of the second sub model, wherein the plane of the first sub model and the plane of the second sub model are each parallel to the direction orthogonal to the output direction;
merging the sub bitmap of the plane of the first sub model with the sub bitmap of the plane of the second sub model to create a merged bitmap, and
providing the merged bitmap to the three-dimensional printer.

23. The method of claim 22, further comprising reassigning the first sub model from the first processor to the second processor, so as to use the second processor to generate a sub bitmap of another plane of the first sub model, wherein the other plane of the first sub model is also parallel to the direction orthogonal to the output direction.
